(19) United States
(12) Patent Application Publication
(10) Pub. No.: US 2005/0271801 A1
(43) Pub. Date: Dec. 8, 2005

(54) Fabric crayon kit and method of using

(76) Inventor: Daniel J. Alexander, Minneapolis, MN (US)

Correspondence Address: JACOBSON & JOHNSON, ONE WEST WATER STREET, SUITE 285, ST. PAUL, MN, 55107, US

(21) Appl. No.: 11/142,209

(22) Filed: May 31, 2005

Related U.S. Application Data
(60) Provisional application No. 60/576,933, filed on Jun. 4, 2004.

(51) Int. Cl. B41M 3/12; B44C 1/165

(52) U.S. Cl. 427/146; 156/230

(57) ABSTRACT

A fabric crayon coloring kit and a method of using the a fabric crayon coloring kit, the fabric crayon coloring kit comprising at least one fabric crayon, a fabric article having a fabric crayon receiving region thereon for applying the fabric crayon thereto, and a backboard for supporting the fabric crayon receiving region of the fabric article thereon as the fabric crayon is applied to the fabric crayon receiving region of the fabric article, the backboard having a surface containing an adhesive for securely maintaining the support of the fabric crayon receiving region of the fabric by the backboard as the fabric crayon is applied to the receiving region of the fabric article.

### CROSS REFERENCE TO RELATED APPLICATIONS

This application claims priority to currently pending U.S. Provisional Application Ser. No. 60/576,933, which was filed on Jun. 4, 2004.

### STATEMENT REGARDING FEDERALLY SPONSORED RESEARCH OR DEVELOPMENT

None

### REFERENCE TO A MICROFICHE APPENDIX

None

### FIELD OF THE INVENTION

This invention relates to fabric decoration, and more specifically, to a fabric crayon kit for decorating fabric articles.

### BACKGROUND OF THE INVENTION

Crayons for drawing and coloring on paper and paper-like mediums are known in the art. The aforementioned crayons, which traditionally are made from paraffin, stearic acid, and colored by a non-toxic pigments are excellent at maintaining their markings on the paper and paper-like mediums. The traditional crayons however are not appropriate for marking fabric articles such as clothing and blankets as they lack the properties to properly maintain their markings to fabric articles. In addition, when applied to the fabric articles, traditional crayons often times leave smearing marks on the fabric articles, especially after the crayon-marked article are washed.

Crayons for marking fabric articles are also known in the art. Unlike the above-mentioned traditional crayons, the fabric crayons have the properties to properly maintain their markings to fabric articles when applied thereto. In use, the user first marks the fabric article with the fabric crayons to obtain a desired design. In order to permanently secure the fabric crayon design on the fabric article, the user then covers the fabric crayon design with a sheet of bond paper after which a heat source, such as a hot iron, is applied to the portion of the fabric article containing the fabric crayon design being covered by the bond paper. The heating of the fabric crayon design functions to impregnate the fabric crayon markings to the fibers of the fabric article thereby permanently securing the crayon design to the fabric article.

Although the above-mentioned fabric crayons function for their intended purpose, namely for marking fabric articles, it can be often difficult to draw or color a desired design to the fabric article with the fabric crayons due to the tendency of fabric articles to flex, slide, and stretch, especially for children under 10, which can lead undesired results.

The present invention is an improvement to the fabric crayons by providing a kit for enhancing the user's ability to draw and color a design to the fabric article in order to obtain desired fabric crayon marking results.

### DESCRIPTION OF THE PRIOR ART

U.S. Pat. No. 5,196,237 teaches a method for making and using crayons which permanently colors a fabric.

U.S. Pat. No. 5,279,859 teaches a method for permanently adhering a crayon material to a fabric and permanently fixing the crayon material onto the fabric.

### SUMMARY OF THE INVENTION

The present invention comprises a fabric crayon coloring kit and a method for using the kit to permanently adhere markings made by fabric crayons to a fabric article. The fabric crayon coloring kit comprises at least one marking fabric crayon, a fabric article such as a clothing article having a region thereon for receiving a fabric crayon marking. The kit also includes a backboard for supporting the fabric crayon receiving region of the fabric thereon as the fabric crayon is applied to the receiving region of the fabric article. The backboard of the fabric crayon coloring kit includes an adhesive for securely maintaining the support of the fabric crayon receiving region of the fabric by the backboard as the fabric crayon is applied to the receiving region of the fabric article. In use of the fabric crayon coloring kit to permanently secure the markings made by fabric crayons to the fabric article a user first temporarily secures the backboard having the adhesive thereon to the fabric article to be marked. The fabric crayon is then applied to the fabric article to create a fabric crayon marking on the fabric article. To permanently secure the markings made by fabric crayons to the fabric article, anon-stick covering is then placed over the fabric crayon marking on the fabric article and a heat source is then applied to the fabric crayon marking on the fabric article.

### BRIEF DESCRIPTION OF THE DRAWINGS

FIG. 1 shows a front view of an embodiment of a fabric crayon kit of the present invention;

FIG. 2 shows the individual components of the fabric crayon kit of FIG. 1;

FIG. 2A shows a front view of a label header of the fabric crayon kit of FIG. 1 with a front portion of the label header removed;

FIG. 3 shows a front view of an alternative embodiment of the present invention comprising a fabric crayon hanger kit;

FIG. 4 shows a top view of an alternative embodiment of the present invention comprising a fabric crayon box kit:

FIG. 5 shows a front view of alternative embodiment of the present invention comprising a fabric crayon header kit;

FIG. 6 shows a partial cross-sectional view of the fabric crayon hanging kit of FIG. 3;

FIG. 7 shows a front view of the label header of the fabric crayon hanging kit of FIG. 3;

FIG. 8 shows a side view of the label header of the fabric crayon hanging kit of FIG. 3;

FIG. 9 shows a back portion of the label header of the fabric crayon hanging kit of FIGS. 3, 6, and 7;

FIG. 10 shows an alternative embodiment of a back portion of a label header similar to the label header of FIGS. 3, 6, and 7; and

FIG. 11 shows the individual articles of the fabric crayon box kit of FIG. 4.

### DESCRIPTION OF THE PREFERRED EMBODIMENT

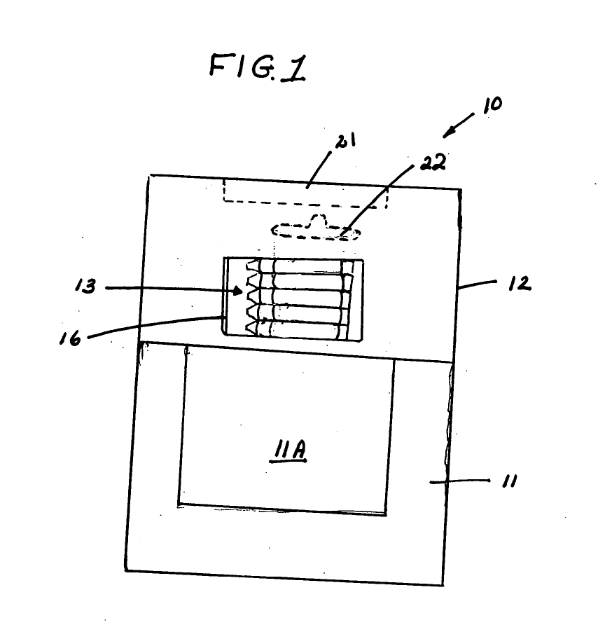

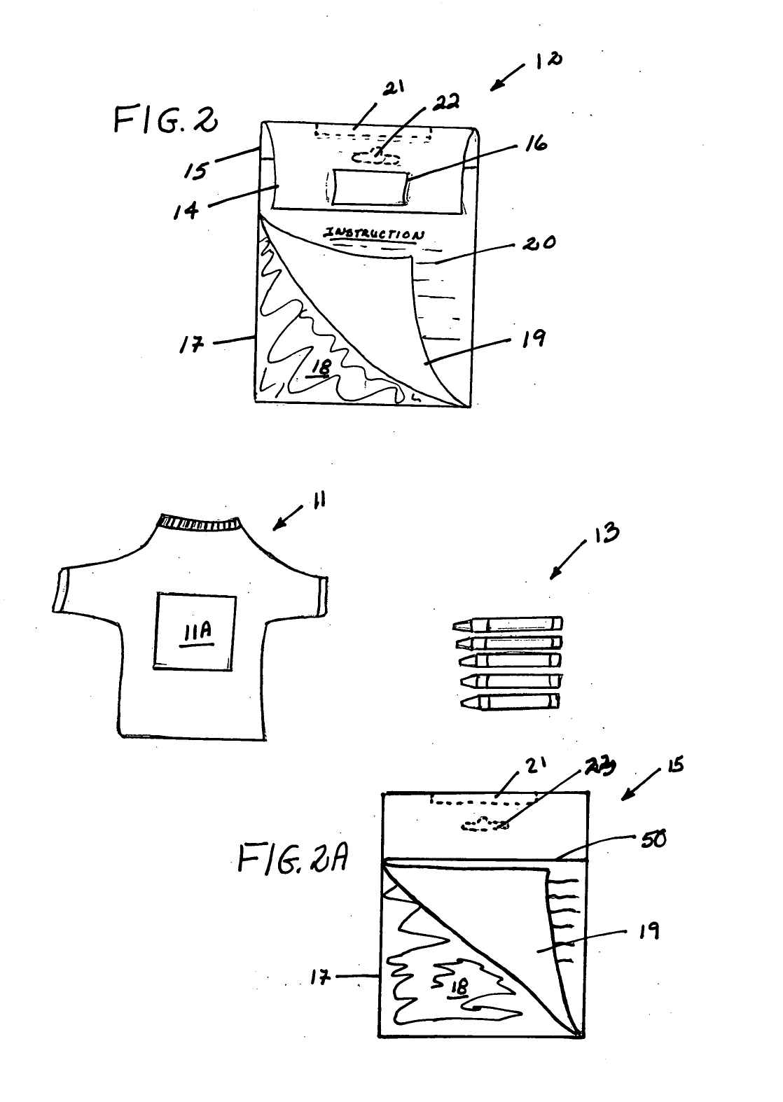

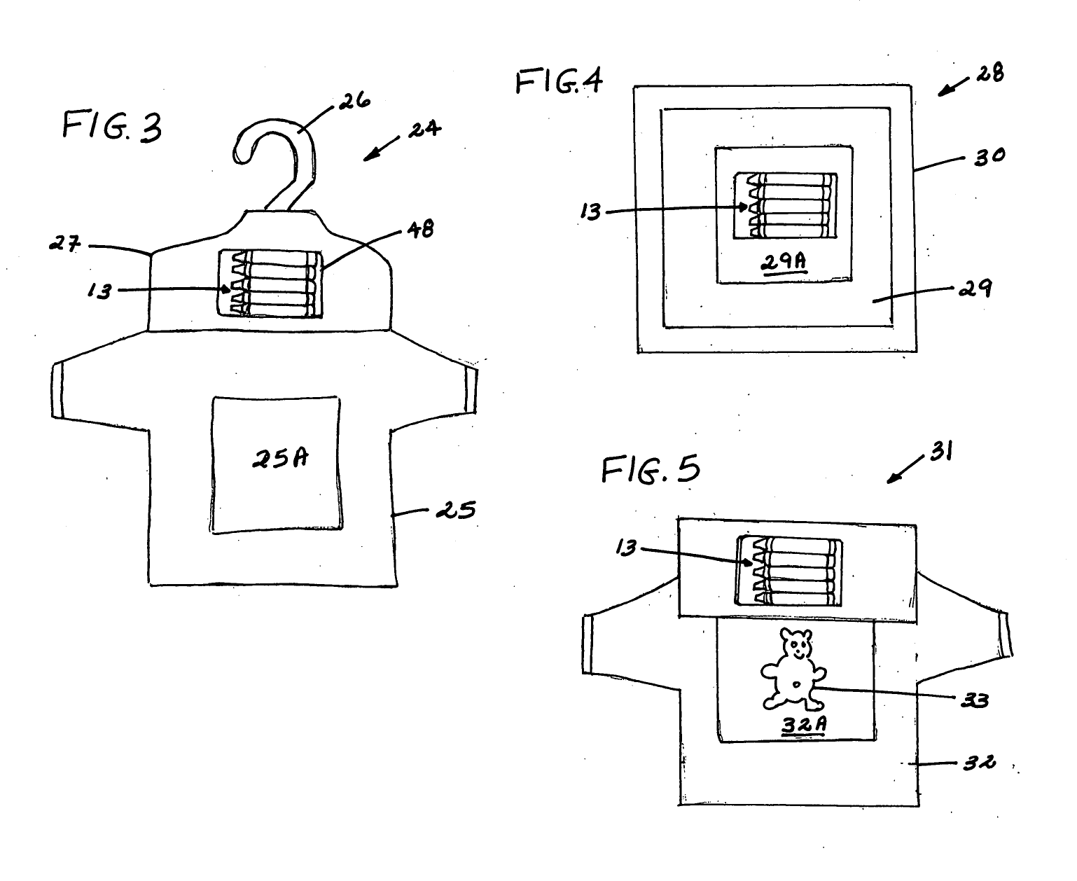

Referring to FIGS. 1, 2, and 2A, FIG. 1 shows a front view of an embodiment of a fabric crayon kit 10 of the present invention. FIG. 2 shows the individual components of the fabric crayon kit 10 of FIG. 1. As shown in FIGS. 1 and 2, fabric crayon kit 10 comprises a fabric article 11, a label header 12, and a set of fabric crayons 13 for decoratively marking fabric article 11. In reference to fabric article 11, it is noted that although the crayons of set of fabric crayons 13 can each generally mark any region on fabric article 11, the embodiment of FIGS. 1 and 2 show fabric article 11 having a fabric crayon receiving region 11A located thereon for specifically receiving fabric crayon markings.

In regards to label header 12, the label header 12 is shown in the embodiment of FIGS. 1 and 2 comprising a front portion 14, a back portion 15, a fabric crayon container 16 located on the front portion 14 of label header 12 for supporting the set of fabric crayons 13 therein, and a backboard 17 integrally formed to and extending from the back portion 15 of label header 12. Referring to FIG. 2A, FIG. 2A shows a front view of label header 12 with the front portion 14 of the label header 12 removed to provide a detailed view of the back portion 15 of the label header 12. It is generally noted that the backboard of the present invention can be made from a variety of materials that are sufficiently rigid to support the receiving region of the fabric article 11 thereon as the fabric crayons of the set of crayons 13 are marked or colored thereto. Examples of some of the materials that the backboard of the present invention can be form from include but are not limited to a cardboard or cardboard-like material, a thin sheet of wood, and a foam tack-board like material. Note that the back portion 15 of the label header 12 is shown in FIG. 2A as including a pre-printed guide-line 50 to help a user to remove the backboard 17 from the back portion 15 of the label header 12 by, for example, cutting the backboard 17 from the label header 12 using a scissor.

Referring to the backboard 17, backboard 17 functions to provide a support surface for fabric article 11 as the set of fabric crayons 13 are applied to the fabric article 11, and more specifically, to the receiving region 11A of the fabric article 11. In order to prevent or reduce the tendency of fabric articles to flex, shift, slide or stretch which can lead undesired fabric crayon marking results, a feature of the present invention is that the backboard 17 of the present invention includes an adhesive, and more preferably a reusable adhesive 18, located thereon for temporarily securing the fabric crayon receiving region 11A of the fabric article 11 to the backboard 17 as the fabric crayons 13 are applied to the receiving region 11A of the fabric article 11.

Use of backboard 17 containing reusable adhesive 18 thereon to support the fabric article 11 during the marking stage is preferred as the aforementioned improves the quality of the decorating of fabric article 11 by temporarily preventing the fabric article 11 from shifting, stretching, or flexing as the fabric article 11 is decoratively being marked by the set of fabric crayons 13. For example, the action of preventing fabric article 11 from shifting, sliding, stretching, or flexing allows a user to increase the pressure that the fabric crayons can be applied to the fabric article 11 thereon thereby resulting in darker and more finely drawn markings. Although various reusable adhesives can be used for the present invention, it is preferred that the reusable adhesive 18 of the present invention comprises an adhesive that does not smear, melt, dry, or permanently bond to the fabric article 11 when the adhesive 18 is exposed to heat.

Referring to FIGS. 2 and 2A, note that fabric crayon kit 10 also includes a protective covering 19 located on the reusable adhesive 18, the protective covering 19 functioning to protect the reusable adhesive 18 of the backboard 17 such as by preventing the adhesive from adhering to unintended objects or articles when the adhesive 18 is not in use. Although protective covering 19 can comprise a plurality of materials that can be easily detached from the reusable adhesive 18, it is preferred that the protective covering 19 include a non-stick surface such as but not limited to a silicone or silicone-like surface to enable protective coating 19 to be easily detached from protective covering 19. Further note in the embodiment of FIGS. 2 and 2A that the protective covering 19 can include printed information 20 located thereon. The printed information 20 can comprise design ideas and instructions for using the kit and can come in multiple languages to enable the printed information 20 to be understood by a broader group of users.

Referring again to protective covering 19, it is noted that a feature of the present invention is that the protective covering 19 can also be used as a cover that can be placed over the receiving region 11A of the fabric article 11 after the fabric article 11 has been marked by the fabric crayon 13 and as a heat source, such as a clothing iron, is applied to the receiving region 11A of the fabric article 11 containing the crayon marking to permanently secure the crayon markings to the fabric article 11. Use of the protective covering 19 is prefer as the non-stick surface of the protective covering 19 prevents protective covering 19 from absorbing very little if any of the crayon markings from the receiving region of the fabric article thereby reducing the possible dullness of crayon markings while also preventing the crayon markings from smearing.

Referring generally to the label header of the present invention, it is noted that the label header of the present invention can also include regions thereon that can be perforated to allow the label header to support the fabric crayon kit of the present invention in various product display holders. For example, FIGS. 1, 2, and 2A, show label header 12 providing for a first region 21 extending from the front portion 14 of the label header 12 to the back portion 15 of the label header 12 that can be perforated to enable label header 12 to receive a portion of a clothes hanger (not shown) therethrough so that the fabric crayon kit 10 can be supported by the clothes hanger in a hanging product display condition.

Further note that label header 12 also includes a second region 22 located on the front portion 14 of the label header 12 and a third region 23 located on the back portion 15 of the label header 12. The second region 22 and the third region 23 are positioned with respect to each other so that the perforation of the second region 22 and the third region from label header 12 forms a slot (not shown) on label header 12 for receiving a peg or rod of a peg or rod product display holder (not shown) therethrough to enable label header 12 to support fabric crayon kit 10 on the peg or rod product display holder.

Referring to FIG. 3, FIG. 3 shows a front view of an alternative embodiment of the present invention comprising a fabric crayon hanger kit 24. As shown in FIG. 3, fabric crayon hanger kit 24 comprises a fabric article 25 having a fabric crayon receiving region 25A located thereon, a set of fabric crayons 13, a hanger such as a clothes hanger 26 for supporting the fabric article 25, and a label header 27 for securing the set of fabric crayons 13, the hanger 26 and the fabric article 25 together.

FIG. 4 shows a top view of an alternative embodiment of the present invention comprising a fabric crayon box kit 28. As shown in FIG. 3, the fabric crayon box kit 28 includes a fabric article 29 having a fabric crayon receiving region 29A located thereon, a set of fabric crayons 13, and a container 30 for holding the aforementioned articles therein.

FIG. 5 shows a front view of alternative embodiment of the present invention comprising a fabric crayon header kit 31. As shown in FIG. 5, fabric crayon header kit 31 comprises similar articles as that of the fabric crayon kit 10 of FIG. 1. However, unlike the fabric crayon kit 10 of FIG. 1, the fabric article 32 of fabric crayon header kit 31 includes pre-printed design 33 located on a fabric crayon receiving region 32A of the fabric article 32, the pre-printed design 33 providing the user with a template to help jump-starting the user's creative work using the fabric crayons. It is noted that the pre-printed design 33 can comprise various figures and images such as but not limited to cartoon characters, animals, flowers, building structure, and nature scenes.

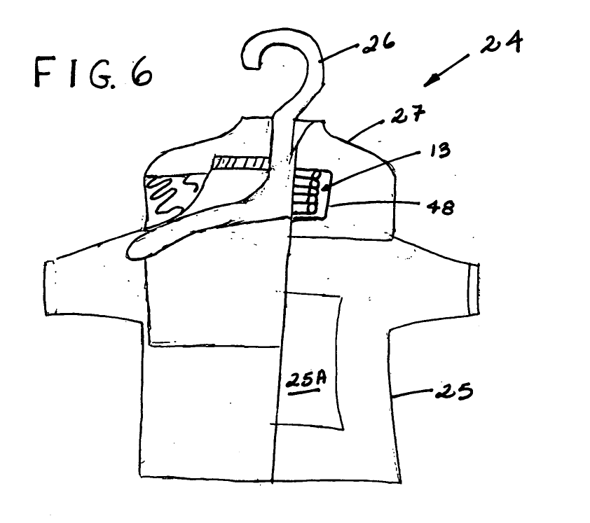

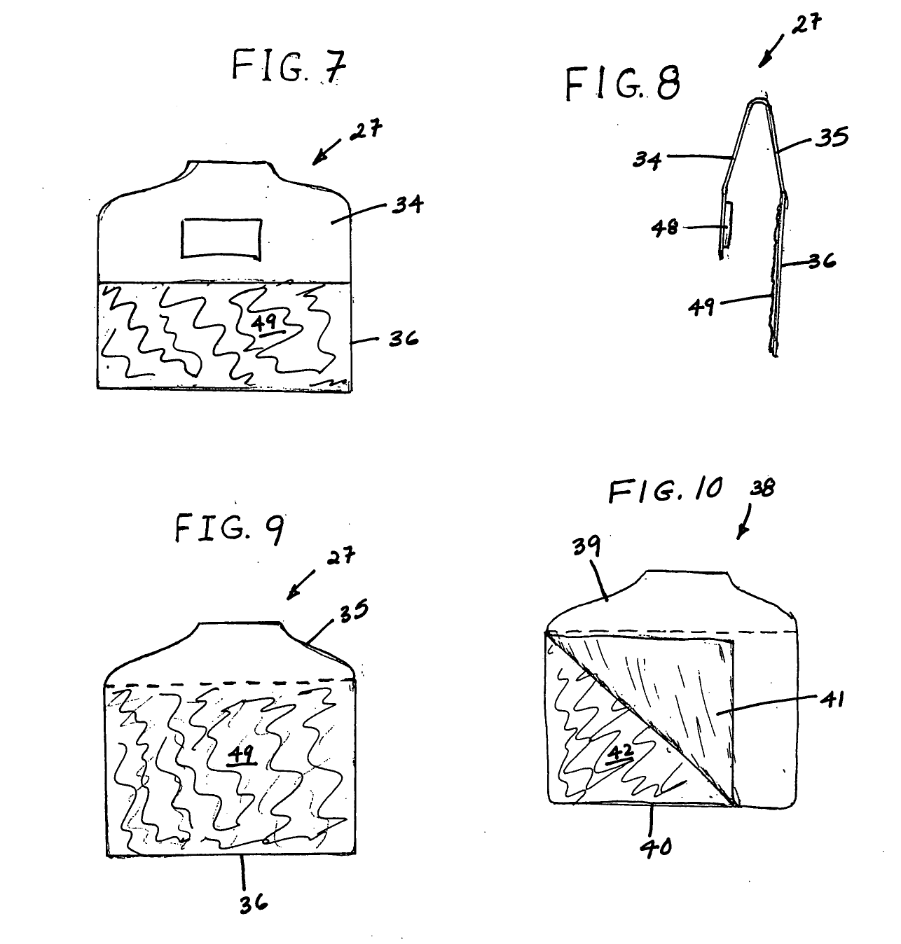

Referring to FIGS. 6, 7, 8, and 9, FIG. 6 shows a partial cross-sectional view of the fabric crayon hanging kit 24 of FIG. 3. FIG. 7 shows a front view and FIG. 8 shows a side view of the label header 27 of the fabric crayon hanging kit 24 of FIG. 3. FIG. 9 shows a back portion 35 of the label header 27 of FIGS. 3, 6, and 7. As shown in FIGS. 3, 6, and 7, the label header 27 of the fabric crayon hanging kit 24 comprises a front portion 34 and the back portion 35. The front portion 34 of label header 27 includes a fabric crayon container 48 located thereon for supporting the set of fabric crayons 13 therein. The back portion 35 of label header 27 includes an integral backboard 36 that can be removed from label header 27 for supporting the receiving region 25A of the fabric article 25 thereon as the set of fabric crayons 13 are applied to the receiving region 25A of fabric article 25.

Similar to the backboard 17 of FIGS. 1, 2, and 2A, use of backboard 36 improves the quality of the decorating of fabric article 25 by temporarily preventing the fabric article 25 from shifting or flexing as the fabric article 25 is decoratively being marked by the set of fabric crayons 13.

Referring to FIG. 9, again, similar to the backboard 17 of FIG. 2A, the back portion 36 of label header 27 can also include a pre-printed guideline 37 located thereon to help a user to remove the backboard from the label header such as by cutting the label header 27 with a scissor.

Referring again to FIGS. 7, 8, and 9, note that backboard 36 also includes a reusable adhesive 49 located thereon for securely maintaining the support of receiving region 25A of the fabric article 25 by the backboard 36 as the fabric crayons of the set of fabric crayons 13 are applied to the receiving region 25A of the fabric article 25.

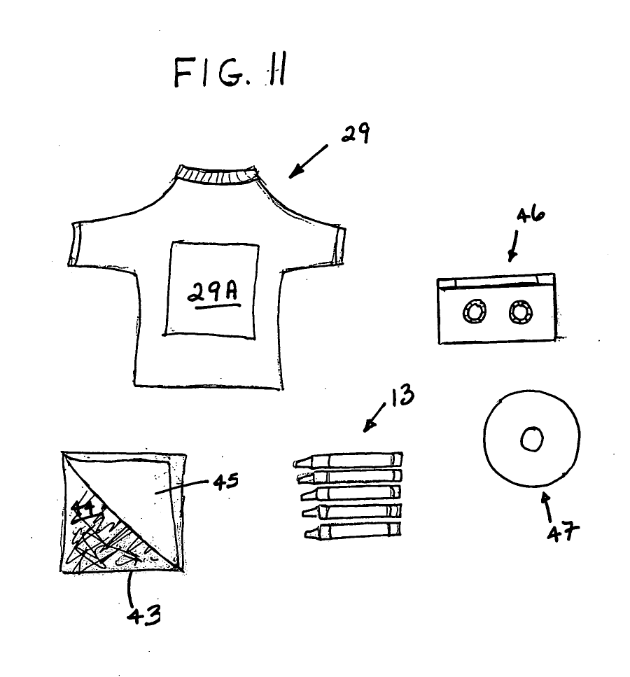

FIG. 10 shows an alternative embodiment of a back portion 39 of a label header 38 similar to the back portion 35 of the label header 27 of FIGS. 8 and 9 but with a backboard 40 of label header 38 including a protective covering 41 located on and protecting a reusable adhesive 42 located on backboard 40.

In use of fabric crayon hanger kit 24, the user first detaches the backboard 40 from the label header 38 such as with a scissor after which the protective covering 41 is then peeled away from the reusable adhesive 42 located on backboard 40 after which the backboard 36 is temporarily secured to the fabric article 25 to support the receiving region 25A of the fabric article 25 thereon as the fabric crayons of the set of fabric crayons 13 are marked or colored on the receiving region 25A of the fabric article 25.

In further regards to protective covering 41, similar to the covering 19 of FIGS. 1, 2, and 2A a further feature of the present invention is that protective covering can also be used as a cover placeable over the receiving region 25A of fabric article 25 containing a fabric crayon marking thereon as a heat source is applied to the receiving region 25A of the fabric article 25 containing the fabric crayon marking to permanently secure the fabric crayon markings to fabric article 25.

Referring to FIG. 11, FIG. 11 shows the individual articles of the fabric crayon box kit 28 of FIG. 4 comprising fabric article 29, the set of fabric crayons 13, a backboard 43 having a reusable adhesive 44 located thereon for temporarily securing backboard 43 to the receiving region 29A of the fabric article 29 during the marking process of the receiving region 29A by the set of fabric crayons 13.

Backboard 43 is also shown in FIG. 11 also including a dual use protective covering 45 which functions not only protect reusable adhesive 44 when backboard 43 is not in use, but also to provide a non-stick cover placeable over the receiving region 29A of fabric article 29 containing a crayon marking thereon as a heat source is applied to the receiving region 29A to permanently secure the crayon markings to the fabric article 29.

In further regards to fabric crayon box kit 28, note that fabric crayon box kit 28 can also include a cassette tape 46 or a compact disc 47 or both containing video and audio instructions on how to use the fabric crayon box kit 28.

The present invention also includes a method of using the fabric crayon kit 10 for permanently adhering markings made by a set of fabric crayons 13 to a fabric article 11 comprising the steps of: (1) temporarily securing a backboard 17 to the fabric article 11 to be marked; (2) applying the set of fabric crayons 13 to the fabric article 11, and more specifically, to a receiving region 11A of the fabric article 11 to create a marking on the receiving region 11A of the fabric article 11; (3) placing a non-stick covering 19 over the receiving region 11A of the fabric article 11 containing the fabric crayon marking; and (4) heating the receiving region 11A of the fabric article 11 containing the fabric crayon marking to permanently secure the fabric crayon marking on the receiving region 11A of the fabric article 11.

The above method also includes the steps of (5) removing the backboard 17 from a label header 12 before securing the backboard 17 to the fabric article 11 to be marked; (6) temporarily securing the backboard 17 to containing a reusable adhesive 18 to the fabric article 11 to be marked; (7) temporarily securing a backboard 17 containing the reusable adhesive 18 to a back side of the receiving region 11A of the fabric article 11 to be marked; (8) applying the set of fabric crayons 13 to a pre-printed design 33 located on the receiving region 32A of the fabric article 32 to create a marking on the pre-printed design 33; (9) adhering the backboard 17 having a reusable non-smearing adhesive 18 to the back side of the fabric article 11 to be marked; (10) placing a non-stick covering 19 over the receiving region 11A of the fabric article 11 containing the fabric crayon marking; (11) heating the receiving region 11A of the fabric article 11 containing the fabric crayon marking with an clothes iron to permanently secure the fabric crayon marking on the receiving region 11A of the fabric article 11; (12) removing the backboard 17 from the fabric article 11 prior to heating the receiving region 11A of the fabric article 11 containing the fabric crayon marking; (13) removing the protective covering 19 from the reusable adhesive 18 and then adhering the backboard 17 containing the reusable adhesive 18 to the backside of the receiving region 11A of the fabric article 11 to be marked; (14) removing a non-stick protective covering 19 from the reusable adhesive 18; and (15) placing the protective covering 19 for protecting the reusable adhesive 18 over the receiving region 11A of the fabric article 11 containing the fabric crayon marking.

1. A fabric crayon coloring kit comprising:
at least one marking fabric crayon;
a fabric article having a fabric crayon receiving region thereon for applying the at least one fabric crayon thereto; and
a backboard for supporting the fabric crayon receiving region of the fabric thereon as the at least one fabric crayon is applied to the fabric crayon receiving region of the fabric article, the backboard having a surface containing a reusable adhesive for securely maintaining the support of the fabric crayon receiving region of the fabric by the backboard as the at least one fabric crayon is applied to the receiving region of the fabric article.

2. The kit of claim 1 wherein the at least one fabric crayon comprises a set of fabric crayons.

3. The kit of claim 1 wherein the fabric article comprises a clothing article.

4. The kit of claim 1 wherein the reusable adhesive comprises an adhesive that does not smear, melt, dry, or permanently bond to the fabric article when the adhesive is exposed to heat.

5. The kit of claim 1 wherein the backboard comprises a foam tack-board like material.

6. The kit of claim 1 wherein the receiving region of the fabric article includes a pre-printed design for coloring.

7. The kit of claim 1 including a label header wherein the backboard is integrally form to the label header.

8. The kit of claim 1 including a dual use protective covering located on the surface of the reusable adhesive, the dual use protective covering detachable from the adhesive.

9. The kit of claim 8 wherein the protective covering includes a non-stick surface, the non-stick surface preventing the protective covering from absorbing the fabric crayon markings from the fabric crayon receiving region of the fabric article as the fabric crayon markings is being permanently secured to the fabric crayon receiving region.

10. The kit of claim 9 wherein the non-stick surface comprises a silicone-like surface.

11. A method for permanently adhering markings made by fabric crayons to a fabric article comprising the steps of:
temporarily securing a backboard having an adhesive thereon to a fabric article to be marked;
applying at least one fabric crayon to the fabric article to create a fabric crayon marking on the fabric article;
placing a non-stick covering over the fabric crayon marking on the fabric article; and
heating the fabric crayon marking on the fabric article to permanently secure the fabric crayon marking on the fabric article.

12. The method of claim 11 wherein the step of applying at least one fabric crayon to the fabric article to create the fabric crayon marking on the fabric article comprises applying at least one fabric crayon to a receiving region of the fabric article to create a fabric crayon marking on the receiving region of the fabric article;

13. The method of claim 11 including the step of removing the backboard from a label header before temporarily securing the backboard to the fabric article to be marked.

14. The method of claim 12 wherein the step of applying at least one fabric crayon to a receiving region of the fabric article to create a fabric crayon marking on the receiving region of the fabric article comprises applying the fabric crayons to a pre-printed design located on the receiving region of the fabric article to create a marking on the pre-printed design.

15. The method of claim 11 wherein the step of placing a non-stick covering over the fabric crayon marking on the fabric article comprises placing a non-stick covering having a non-stick silicone-like surface thereon over the fabric crayon marking on the fabric article.

16. The method of claim 11 wherein the step of heating the fabric crayon marking on the fabric article to permanently secure the fabric crayon marking on the fabric article comprises heating the fabric crayon marking on the fabric article with a heated clothes iron to permanently secure the fabric crayon marking on the fabric article.

17. The method of claim 11 including the step of removing the backboard from the fabric article prior to heating the fabric crayon marking on the fabric article to permanently secure the fabric crayon marking on the fabric article.

18. The method of claim 11 wherein the step of temporarily securing a backboard having an adhesive thereon to a fabric article to be marked comprises removing a protective covering protecting the reusable adhesive and then temporarily adhering the surface of the backboard containing the reusable adhesive to a backside of the fabric article to be marked.

19. The method of claim 18 wherein the step of applying at least one fabric crayon to the fabric article to create a fabric crayon marking on the fabric article comprises applying a set fabric crayons to the fabric article to create a fabric crayon marking on the fabric article.

20. A method for permanently adhering markings made by fabric crayons to a fabric article comprising the steps of:
temporarily securing a backboard having an adhesive thereon to a fabric article to be marked;
applying at least one fabric crayon to a receiving region of the fabric article to create a fabric crayon marking on the receiving region of the fabric article;
placing a protective covering over the receiving region of the fabric article containing the fabric crayon marking; and
heating the receiving region of the fabric article containing the fabric crayon marking to permanently secure the fabric crayon marking on the receiving region of the fabric article.
